(19) United States
(12) Patent Application Publication
(10) Pub. No.: US 2016/0215851 A1
(43) Pub. Date: Jul. 28, 2016

(54) TORQUE TRANSMISSION DEVICE

(71) Applicant: SCHAEFFLER TECHNOLOGIES AG & CO. KG, Herzogenaurach (DE)

(72) Inventor: Stephan Maienschein, Baden-Baden (DE)

(21) Appl. No.: 15/023,901

(22) PCT Filed: Sep. 8, 2014
(86) PCT No.: PCT/DE2014/200450

§ 371 Date: Mar. 22, 2016

(30) Foreign Application Priority Data
Sep. 26, 2013 (DE) 10 2013 219 429.3

(51) Int. Cl. F16F 15/123

(52) U.S. Cl. CPC F16F 15/12353

(57) ABSTRACT

A torque transfer device having a spring damper and a centrifugal pendulum, the torque transfer device being rotatable around an axis of rotation, the centrifugal pendulum having a pendulum flange and at least one pendulum mass, the pendulum mass being connected to the pendulum flange by means of a sliding block guide, the sliding block guide prescribing an oscillation path of the pendulum mass, the pendulum mass being designed to oscillate along the oscillation path, the pendulum flange being torsionally connected to the spring damper, the spring damper being designed to transfer a torque, a switching device being provided, the switching device being coupled with the spring damper, the switching device being designed to reduce the oscillating motion of the pendulum mass along the oscillation path at least partially when a predefined threshold value of the torque is exceeded.

### CROSS-REFERENCE TO RELATED APPLICATIONS

The present application is the United States National Stage Application pursuant to 35 U.S.C. §371 of International Patent Application No. PCT/DE2014/200450, filed Sep. 8, 2014, and claims priority to German Patent Application No. 10 2013 219 429.3, filed Sep. 26, 2013, which applications are incorporated by reference in their entireties.

### FIELD OF THE INVENTION

The invention relates to a torque transfer device.

### BACKGROUND OF THE INVENTION

Torque transfer devices having a spring damper, a centrifugal pendulum and a converter clutch are known. The torque transfer device in such cases is designed to transfer a torque coming from an internal combustion engine to a gear unit, while compensating for fluctuations in the torque. This enables the drivetrain to be designed for especially low noise, while at the same time opening up the possibility of operating internal combustion engines at a lower speed. This enables the fuel consumption of the internal combustion engine to be reduced. Especially in internal combustion engines having cylinder deactivation, the torque transfer devices may be stimulated to unfavorable eigenmodes in the drivable range of the internal combustion engine, which may have an adverse influence on driving comfort.

### SUMMARY OF THE INVENTION

The object of the invention is to make an improved torque transfer device available.

This object is fulfilled by means of a torque transfer device. Advantageous embodiments are specified in the subordinate claims.

According to the invention, it has been recognized that an improved torque transfer device can be made available by having the torque transfer device include a spring damper and a centrifugal pendulum. The torque transfer device is mounted so that it can rotate around an axis of rotation. The centrifugal pendulum includes a pendulum flange and at least one pendulum mass. The pendulum mass is joined to the pendulum flange by means of a sliding block guide. The sliding block guide acts as an oscillation path. The pendulum mass is designed to swing along the oscillation path. The pendulum flange is joined torsionally to the spring damper. The spring damper is designed to transmit a torque. Also provided is a switching device, the switching device being coupled with the spring damper. The switching device is designed to reduce the oscillating motion of the pendulum mass along the oscillation path at least partially, when a predefined threshold value of the torque is exceeded.

This design has the advantage that it provides an additional degree of freedom for designing the torque transfer, so that for example rotational speed ranges or torque ranges in which the centrifugal pendulum may be stimulated to oscillate in unfavorable eigenmodes can be avoided. This makes the torque transfer device especially well-suited for internal combustion engines having cylinder deactivation.

In another embodiment, the spring damper has an input part, an energy storage element and an output part. The output part is coupled with the input part by means of the energy storage element so that it can rotate around the axis of rotation. Furthermore, the input part and the output part are coupled with the switching device.

In another embodiment, the switching device includes a control disk and an actuating element, the control disk being situated so that it is rotatable in relation to the actuating element around the axis of rotation.

In another embodiment, the control disk is connected to the input part and the actuating element to the output part. Alternatively, the control disk is connected to the output part and the actuating element to the input part. This design has the advantage that when the input part is rotated relative to the output part, the control disk is simultaneously rotated relative to the actuating element. In this case, the rotation of the input part relative to the output part is dependent on the level of torque to be transmitted via the spring damper.

In another embodiment, the actuating element includes on a side facing toward the control disk a first ramp section running in the circumferential direction, and the control disk includes on a side facing toward the actuating element a second ramp section running in the circumferential direction, the first ramp section and the second ramp section being designed to be brought into contact with each other when the predefined threshold value of the torque is exceeded. The control disk is designed to be moved axially at least partially in the direction of the pendulum mass when the first ramp section is in direct contact with the second ramp section, in order to come into frictional contact with the pendulum mass and to at least partially reduce an oscillating motion of the pendulum mass. The damping behavior of the centrifugal pendulum can be adapted thereby, depending on the torque to be transmitted via the torque transfer device. In particular, it can be activated or deactivated.

In another embodiment, the actuating element has a first ring section and a second ring section. The two ring sections are positioned in a plane perpendicular to the axis of rotation. The first ring section is offset axially relative to the second ring section. The ramp section is positioned between the first ring section and the second ring section in the circumferential direction. This design makes it possible to produce the actuating element especially cost-effectively, by means of a punch bending procedure.

In another embodiment, the control disk has a first control disk section and a second control disk section. The two control disk sections are positioned in a plane perpendicular to the axis of rotation. The first control disk section is offset axially relative to the second control disk section. The control disk is positioned axially relative to the actuating element in such a way that before the predefined threshold value is exceeded the first control disk section bears against the first ring section and the second ring section bears against the second control disk section.

In another embodiment, the first ramp section and/or the second ramp section is positioned obliquely at an acute angle to the first and/or second ring section and/or to the first and/or second control disk section. The angle is preferably 5° to 30°, in particular 10° to 20°. This ensures that the ramp section surfaces can slide on each other, and that a high staying force can be provided to slow the pendulum mass at the same time.

In another embodiment, the control disk has a first friction surface on a side facing toward the pendulum mass and the pendulum mass has a second friction surface on the side facing toward the control disk; the two friction surfaces being designed to brace an oscillating torque of the pendulum mass relative to the spring damper when there is frictional contact. The oscillating torque, and thus the elimination of torque fluctuations, can be effectively reduced thereby in a simple way.

In another embodiment, a spring element is positioned between the control disk and the pendulum flange. The spring element is designed to provide a separation force to space the pendulum mass apart axially from the control disk, the spring element preferably being designed as a diaphragm spring. This design has the advantage that unwanted rubbing of the friction surfaces or unwanted contact of the control disk on the pendulum mass is reliably avoided.

In another embodiment, the control disk has a first control disk zone, a second control disk zone and a third control disk zone, the control disk zones being connected to each other, the first control disk zone being positioned parallel to the axis of rotation, the second control disk zone being positioned in a plane running perpendicular to the axis of rotation, while the third control disk zone is located radially outside bordering on the second control disk zone, the third control disk zone being positioned in a plane perpendicular to the axis of rotation and offset axially from the second control disk zone, the third control disk zone being positioned axially between the second control disk zone and the pendulum mass. This makes it possible to prevent the second control disk zone, in which the second ramp section is located, from coming into direct contact with the pendulum mass.

### BRIEF DESCRIPTION OF THE SEVERAL VIEWS OF THE DRAWINGS

The invention will be explained in greater detail below on the basis of figures. The figures show the following:

FIG. 1 is a longitudinal section through a torque transmission device;

FIG. 2 is an enlarged detail of the longitudinal section of the torque transfer device shown in FIG. 1;

FIG. 3 is a sectional view along a sectional plane A-A shown in FIG. 1, in a first operating state of the torque transfer device;

FIG. 4 is a sectional view along the sectional plane A-A shown in FIG. 1 through the torque transfer device in a second operating state;

FIG. 5 is a sectional view along a sectional plane C-C shown in FIG. 2 through the torque transfer device;

FIG. 6 is a diagram of a torque pattern, plotted over a torsional angle; and,

FIG. 7 is a diagram of a torque pattern, plotted over the torsional angle.

### DETAILED DESCRIPTION OF THE INVENTION

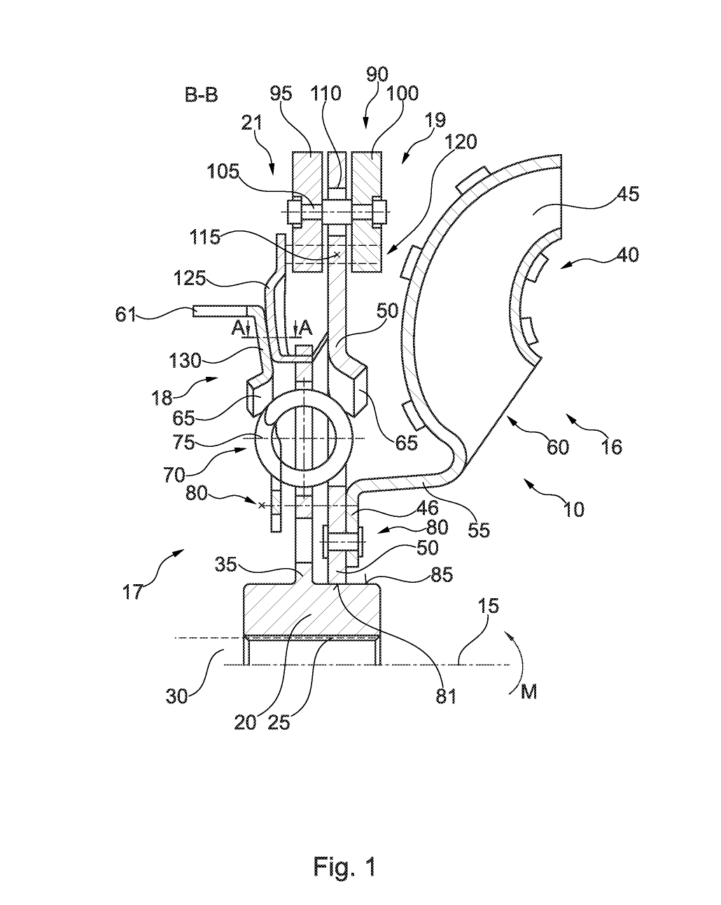

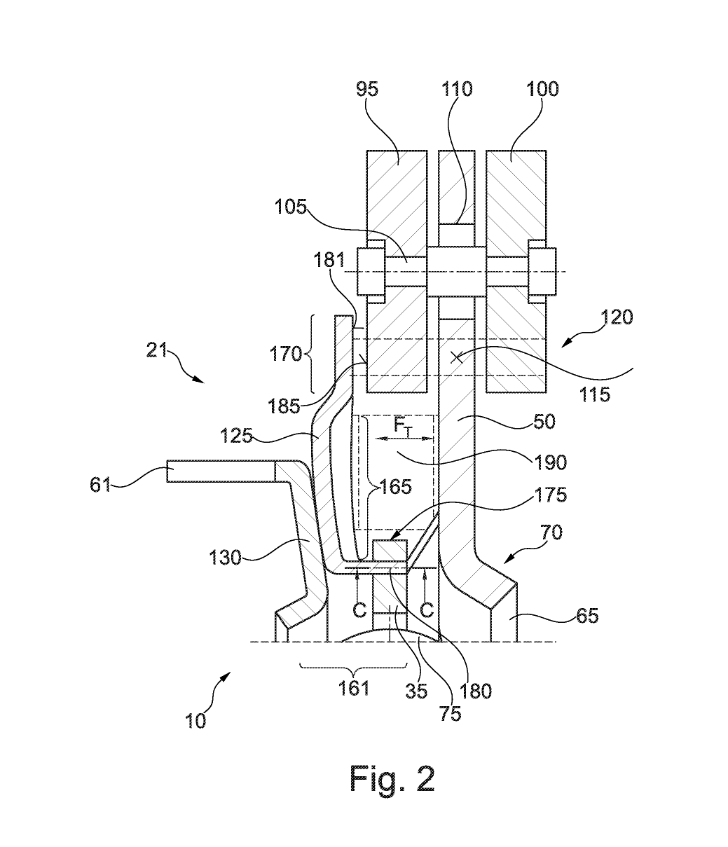

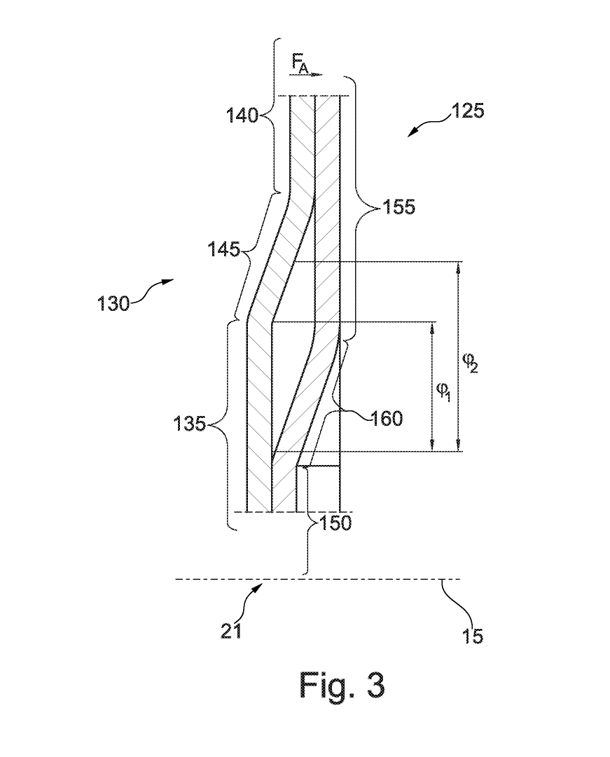

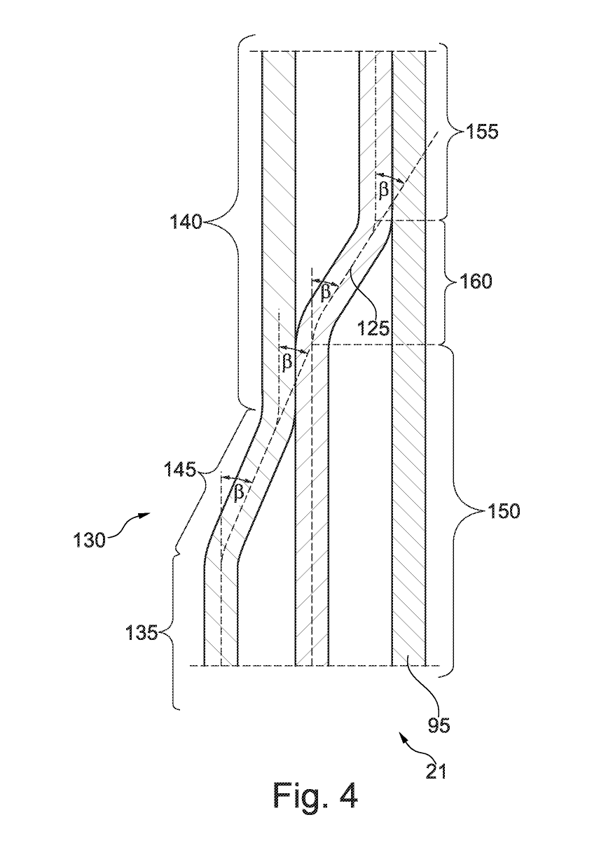

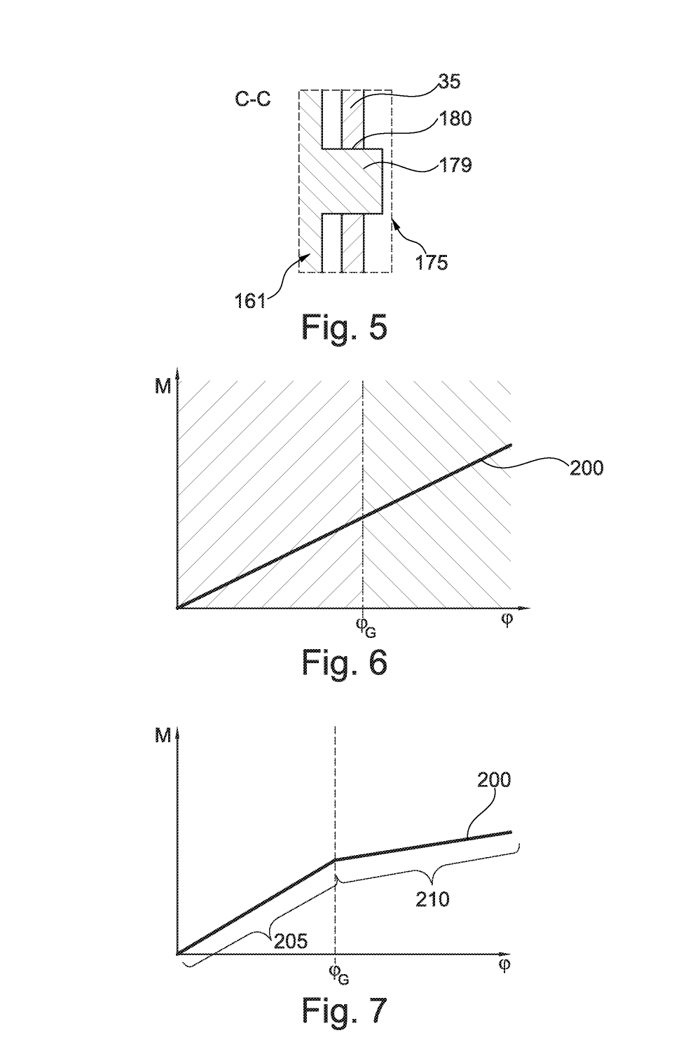

FIG. 1 shows a longitudinal section along a sectional plane B-B through the torque transfer device 10. FIG. 2 shows an enlarged detail of the longitudinal section of the torque transfer device 10 shown in FIG. 1. FIG. 3 shows a sectional view along a sectional plane A-A shown in FIG. 1 in a first operating state, and FIG. 4 shows a longitudinal section along the sectional plane A-A shown in FIG. 1 through the torque transfer device 10 in a second operating state. FIG. 5 shows a sectional view along a sectional plane C-C shown in FIG. 2 through the torque transfer device.

The torque transfer device 10 is mounted so that it can rotate around an axis of rotation 15. In this case, the torque transfer device 10 is part of a drivetrain of a motor vehicle. The torque transfer device 10 has an input side 16 and an output side 17. The input side 16 may be connected to a pump of a hydrodynamic converter 60, for example by means of a fluid stream. The output side 17 may be connected, for example, to a transmission.

The torque transfer device 10 includes a spring damper 18, a centrifugal pendulum 19 and a switching device 21. On the output side 17, the torque transfer device 10 has a hub 20. Radially on the inner side the hub 20 has a shaft-hub connection 25. The shaft-hub connection 25 provides a torsional connection to a transmission input shaft 30 of the transmission. Radially on the outer side of the hub 20 an output part 35 is provided, which is connected to the hub 20. The output part 35 extends radially outward.

On the input side, the torque transfer device 10 has an input part 40, which includes a turbine 45 of the hydrodynamic converter 60, a pendulum flange 50 of the centrifugal pendulum 19, and an input disk 61. The turbine 45 has a turbine flange 46. The turbine flange 46, the pendulum flange 50 and the input disk 61 are connected to each other by means of positive connections 80. Axially, the positions of the turbine 45, the pendulum 50 and the input disk 61 are determined by the output part 35 located between the pendulum flange 50 and the input disk 61.

The input disk 61 and the pendulum flange 50 have tabs 65 which form a retainer 70. The output part 35 is positioned in the axial direction between the input disk 61 and the pendulum flange 50, and extends radially outward through the retainer 70. An energy storage element 75 is positioned in the retainer 70. The energy storage element 75 is designed as a bow spring in this embodiment, and extends essentially in the circumferential direction to the axis of rotation 15. It is of course also conceivable that the energy storage element 75 may be designed as a straight-line coil spring.

The pendulum flange 50 is connected on a side facing away from the output part 35 to the turbine 45, through the positive connection 80. In this embodiment, the positive connection 80 has the form of a riveted connection. On an inner circumferential surface 81 of the pendulum flange 50, the latter rests against an outer circumferential surface on the hub 20. At the same time, the pendulum flange 50 is rotatable in relation to the hub around the axis of rotation 15. The centrifugal pendulum includes a pendulum mass pair 90 radially on the outside on the pendulum flange 50. The pendulum mass pair 90 comprises a first pendulum mass 95 located on the left side of the pendulum flange 50 and a second pendulum mass 100 located on the right side of the pendulum flange 50. The pendulum mass pair 90 also has at least one spacing bolt 105 to connect the pendulum masses 95, 100 with each other. In this case, the spacing bolt 105 is passed through a first cutout 110 of the pendulum flange 50. Furthermore, the centrifugal pendulum 19 includes a sliding block guide 120. The sliding block guide 120 is designed to guide the pendulum masses 95, 100 along a predefined oscillation path 115.

The switching device 21 is located axially between the input disk 61 and the pendulum flange 50, and radially to the outside of the output part 35. The switching device 21 comprises a control disk 125 and an actuating element 130. The actuating element 130 is integrated into the input disk 61.

The actuating element 130 (see FIGS. 3 and 4) includes in the circumferential direction a first ring section 135 and a second ring section 140. The first ring section 135 and the second ring section 140 are each positioned on a plane which is situated perpendicular to the axis of rotation 15. The first ring section 135 is offset in the axial direction relative to the second ring section 140. A first ramp section 145 is provided between the first ring section 135 and the second ring section 140 in the circumferential direction. The first ramp section 145 connects the first ring section 135 to the second ring section 140 in the circumferential direction. The first ramp section 145 is thus positioned obliquely to the first ring section 135 and the second ring section 140. The first ramp section 145 encloses an angle β with the first ring section 135 and/or the second ring section 140. The angle β is an acute angle. The angle β (see FIG. 4) preferably has an angular range of from 5° to 30°, in particular from 10° to 20°.

The control disk 125 has in the circumferential direction a first control disk section 150 and a second control disk section 155. The first control disk section 150 and the second control disk section 155 are each positioned in a plane perpendicular to the axis of rotation 15. The first control disk section 150 is offset axially relative to the second control disk section 155. Between the first control disk section 150 and the second control disk section 155, a second ramp section 160 is provided in the control disk 125. Furthermore, the second ramp section 160 is positioned parallel to the first ramp section 145. Thus, the second ramp section 160 is likewise positioned at an acute angle β (see FIG. 4) to the first control disk section 150 and the second control disk section 155. The first control disk section 150 is connected to the second control disk section 155 in the circumferential direction through the second ramp section 160. The control disk 125 can be produced cost-effectively for example by means of a punch bending process. At the same time, the first control disk sections 150, 155 and/or the second ramp section 160 may be impressed into the control disk 125 in a simple manner.

The control disk 125 (see FIG. 2) has in the radial direction a first control disk zone 161, a second control disk zone 165 and a third control disk zone 170. The control disk zones 161, 165, 170 are connected to each other. At the same time, the first control disk zone 161 is positioned parallel to the axis of rotation 15. The first control disk zone 160 provides a connection 175 to the output part 35.

For the torsionally locked but axially movable connection 175, the first control disk section 161 has a pin section 179 located at the free end of the control disk section 161 (see FIG. 5). Furthermore, the connection 175 includes a third cutout 180 in the output part 35. The third cutout 180 is designed corresponding to the pin section 179. The pin section 179 is designed wider in the axial direction than the output part 35, in order to ensure reliable engagement of the pin section 179 in the third cutout 180 even when the control disk 125 is moved axially. For consistent torque transfer, a plurality of cutouts 180 and pin sections 179 are provided in the circumferential direction. The third cutout 180 and the pin section 179 are positioned parallel to the axis of rotation 15. This makes it possible to provide a connection 175 between the control disk 125 and the output part 35 which is movable in the axial direction but torsionally locked.

The second control disk section 165 is positioned at right angles to the first control disk section 161, and extends radially outward from the first control disk section 161. The second control disk section 165 is located approximately at the radial level of the actuating element.

The third control disk zone 170 adjoins the second control disk zone 165 radially on the outside. The second control disk zone 165 and the third control disk zone 170 are positioned in a plane perpendicular to the axis of rotation 15, offset axially from each other. In this case, the third control disk zone 170 is located at the radial level of the pendulum masses 95, 100. The third control disk zone 170 has a first friction surface 181 on a side facing toward the first pendulum mass 95. The first pendulum mass 95 has a second friction surface on a side facing toward the third control disk zone 170. The third control disk zone 170 is located between the second control disk zone 165 and the first pendulum mass 95 in the axial direction.

In addition, a spring element 190 may be provided between the control disk 125 and the pendulum flange 50, which is designed to provide a separation force F_{T} in order to push the control disk 125 in the direction of the actuating element 130. The separation force F_{T} is aligned parallel to the axis of rotation 15. The spring element 190 may be designed, for example, as a diaphragm spring. This design has the advantage that the spring element 190 is especially cost-effective and construction-space-efficient.

During operation of the torque transfer device 10, the torque transfer device 10 rotates around the axis of rotation 15. In the ideal load-free state of the torque transfer device 10 there is no rotation of the output part 35 relative to the input part 40 (see FIG. 3) in the load-free state. The rotation of the input part 40 relative to the output part 35 is identical to the rotation of the control disk 125 relative to the actuating element, and they each have the same torsional angle φ relative to each other.

If a torque M is introduced into the torque transfer device 10, then the torque M is absorbed through the input side 16 by the pendulum flange 50 and the input disk 61 which is coupled with the pendulum flange 50. The pendulum flange 50 and the input part 61 bear against a first longitudinal end of the energy storage element 75. The input side 16 is tensioned opposite the output side 17 by the torque M being transmitted. The pendulum flange 50 and the input disk 61 press against a first longitudinal end of the energy storage element 70 and compress the energy storage element 70. This causes the input part 40 to rotate relative to the output part 35. The torque M is passed along by the energy storage element 75, and is transferred at a second longitudinal end of the energy storage element 75 by the output part 35 into the hub 20 and through the shaft-hub connection 25 into the transmission input shaft 30. As this occurs, the input part 40 rotates in relation to the output part 35 in direct proportion to the torque M being transferred. The torsional angle φ of the rotation of the input part 40 in relation to the output part 35 is a direct measure of the torque M being transferred by the torque transfer device 10.

If a time-fluctuating torque M is introduced as torsional vibration into the torque transfer device 10, the pendulum masses 95, 100 are excited to oscillate along the oscillation path. The pendulum masses 95, 100 oscillate phase-shifted from the pattern of the fluctuating torque M. As they oscillate, the pendulum masses 95, 100 provide an oscillating torque M_{P}, which is phase-shifted from the pattern of the fluctuating torque M and at least partially cancels the fluctuating torque. Furthermore, a fluctuating torque M is additionally canceled by the energy storage element 75, so that a torque M of the transmission input shaft 30 with especially little fluctuation can be provided at the output side 17.

In this embodiment, the actuating element 130 is connected to the input side 16 and the control disk 125 to the output side 17. It is of course also conceivable for the control disk 125 to be coupled with the output side 17 and the input part 40 with the input side 16.

In a first operating state (see FIG. 3), the first ring section 135 bears against the first control disk section 150. Furthermore, the second ring section 140 bears against the second control disk section 155. The two ramp sections 145, 160 are oriented parallel to each other and are spaced apart by a first torsional angle φ₁. In the first operating state, the first friction surface 181 is spaced apart in the axial direction from the second friction surface 185 of the first pendulum mass 95.

The control disk 125 rotates in relation to the actuating element 130 depending on the torque to be transferred by the torque transfer device 10. If a torque M is transferred, which results in a rotation of the input part 40 in relation to the output part 35 by at least the first torsional angle φ₁, the first ramp section 145 enters into direct contact with the second ramp section 160.

If the torque M being transferred increases further, then the control disk 125 is pressed axially in the direction of the first pendulum mass 95 by the obliquely positioned ramp sections 145, 160. The first ring section 135 is thereby separated from the first control disk section 150, since the second ramp section 160 slides along the first ramp section 145 and is pressed in the axial direction. When a predefined threshold value for the torque M which correlates with a second torsional angle φ₂ is exceeded, the first friction surface 181 enters into direct contact with the second friction surface 185. The two friction surfaces 181, 185 build up a friction contact, whereby the oscillation motion of the pendulum masses 95, 100 along the oscillation path 115 is reduced or blocked, and the function of the centrifugal pendulum 19 is deactivated. As this occurs, the oscillating torque produced by the pendulum masses 95, 100 is supported against the output part 35 by means of the control disk 125. This makes it possible to prevent the pendulum masses 95, 100 from striking other pendulum masses (not shown) at a high torque M, or the spacing bolt 105 from striking the first cutout 110. The torque transfer device 10 can thereby guarantee especially smooth driving operation.

Depending on the torsional angle φ in the second operating state, a contact force F_{A} with which the first friction surface 181 is pressed against the second friction surface 185 is defined, and the oscillating motion of the pendulum masses 95, 100 is reduced or completely blocked. By coordinating the extent of the ramp sections 160, 145 in the circumferential direction and the angle φ, the contact force with which the first friction surface 181 presses against the second friction surface 185 in the second operating state can be adjusted by design.

If the first friction surface 181 presses against the second friction surface 185; on the reverse side the first pendulum mass 95 is pressed on the side facing the pendulum flange 50 against the pendulum flange 50, so that the first pendulum mass 95 is hindered or blocked in its oscillating motion along the oscillation path 115. The blocking is passed from the first pendulum mass 95 through the spacing bolt 105 to the second pendulum mass 100.

If the torque M being transferred is less than the predefined threshold value of the torque M, then it corresponds to a torsional angle φ of the control disk 125 in relation to the actuating element 130, which is smaller than the second torsional angle φ₂. The second ramp section 160 slides back again along the first ramp section 140, so that the control disk 125 in FIG. 1 is again shifted to the left and the frictional contact of the two friction surfaces 181, 185 is canceled. The separation of the first friction surface 181 from the second friction surface 185 is ensured by the spring element 190 which may be additionally provided.

FIG. 6 shows a diagram in which the torque M being transferred is plotted over the torsional angle φ. The torque M follows a characteristic curve 200. The characteristic curve is a straight line in this embodiment, and has a constant slope. It is of course also conceivable for the characteristic curve 200 to have multiple stages, i.e., to have a bend, as shown, for example, in FIG. 7.

As explained earlier, the predefined threshold value for the torque M corresponds to the predefined second torsional angle φ₂. In the first operating state, the torsional angle φ is smaller than the second torsional angle φ₂. In this operating state, the friction forces 181, 185 are separated from each other, so that the pendulum masses 95, 100 can oscillate unhindered along the oscillation path 115. In this area, the centrifugal pendulum 19 is thus active. Through the coupling of the canceling properties of the spring damper 18 and of the centrifugal pendulum 19, in the first operating state the characteristic curve 200 has a first characteristic curve segment 205.

If the torsional angle φ exceeds the second torsional angle φ₂, or if the torque M being transferred exceeds the predefined threshold value for the torque M, then the friction surfaces 181, 185 are pressed against each other and the oscillating motion of the pendulum mass pair 90 is impeded or blocked. As a result, the characteristic curve 200 has a second characteristic curve segment 210. Damping of torque fluctuations present in the torque when the centrifugal pendulum 19 is deactivated now only occurs by means of the spring damper 18 and the converter 60.

FIG. 7 shows a diagram in which the torque M being transferred is plotted over the torsional angle φ. The behavior of the torque transfer device 10 in the first operating state corresponds to the behavior described in FIG. 6. In contrast thereto, the characteristic curve 200 has a second characteristic curve segment 210, which has a different slope than the first characteristic curve segment 205. As a result, the torque transfer device 10 behaves differently when the centrifugal pendulum 19 is deactivated than when the centrifugal pendulum 19 is activated. As a result, the torque transfer device 10 is especially well suited for internal combustion engines having cylinder deactivation, since by means of the two-stage characteristic curve 200, as shown in FIG. 7, the torque transfer device 10 can be adapted to the respective engine operating state in a simple way and the torsion spring rate of the torque transfer device 10 can be adapted optimally in a simple way. Inability of the centrifugal pendulum 19 to be excited to unwanted normal modes when a cylinder is deactivated is also prevented, since the centrifugal pendulum 19 is deactivated in this case.

It should be pointed out that the switching device 21 shown in FIGS. 1 through 7 can of course be designed differently. An essential point here is that an axial offset of the first friction surface 181 occurs depending on the torsional angle or on the torque. So it is conceivable, for example, to provide a protrusion on the actuating element 130 or on the control disk 125, instead of the ramp sections 145, 160.

### REFERENCE LABELS

10 torque transfer device
15 axis of rotation
16 input side
17 output side
18 spring damper
19 centrifugal pendulum
20 hub
21 switching device
25 shaft-hub connection
30 transmission input shaft
35 output part
40 input part
45 turbine
50 pendulum flange
60 hydrodynamic converter
61 input disk
65 strap
70 retainer
75 energy storage element
80 positive connection
81 inner circumferential surface
85 outer circumferential surface
90 pendulum mass pair
95 first pendulum mass
100 second pendulum mass
105 spacing bolt
110 first cutout
115 oscillation path
120 sliding block guide
125 control disk
130 actuating element
135 first ring section
140 second ring section
145 first ramp section
150 first control disk section
155 second control disk section
160 second ramp section
161 first control disk zone
165 second control disk zone
170 third control disk zone
175 connection
179 pin section
180 third cutout
181 first friction surface
185 second friction surface
190 spring element
200 characteristic curve
205 first characteristic curve segment
210 second characteristic curve segment

What is claimed is:

1-11. (canceled)

12: A torque transfer device mounted so that it can rotate around an axis of rotation, the torque transfer device comprising:
a spring damper designed to transfer a torque; and,
a centrifugal pendulum including a pendulum flange and at least one pendulum mass, where the pendulum mass is connected to the pendulum flange by means of a sliding block guide, the sliding block guide predetermines an oscillation path of the pendulum mass, the pendulum mass is designed to oscillate along the oscillation path, the pendulum flange is torsionally connected to the spring damper;
wherein a switching device is coupled with the spring damper and designed to reduce the oscillating motion of the pendulum mass along the oscillation path at least partially when a predefined threshold value of the torque is exceeded.

13: The torque transfer device of claim 12, wherein the spring damper includes an input part, an energy storage element and an output part, the output part being coupled with the input part by means of the energy storage element so that it is rotatable around the axis of rotation, the input part and the output part being coupled with the switching device.

14: The torque transfer device of claim 12, wherein the switching device includes a control disk and an actuating element, the control disk being situated so that it is rotatable in relation to the actuating element around the axis of rotation.

15: The torque transfer device of claim 13, wherein the switching device includes a control disk connected to the input part and an actuating element connected to the output part, or in that the control disk is coupled with the output part and the actuating element is coupled with the input part.

16: The torque transfer device of claim 14, wherein:
the actuating element includes, on a side facing toward the control disk, a first ramp section running in a circumferential direction, and the control disk includes, on a side facing toward the actuating element, a second ramp section running in the circumferential direction;
the first ramp section and the second ramp section being designed to be brought into direct contact when the predefined threshold value of the torque is exceeded; and,
the control disk is designed to be moved axially at least partially in the direction of the pendulum mass when the first ramp section is in direct contact with the second ramp section, in order to come into frictional contact with the pendulum mass and to reduce an oscillating motion of the pendulum mass at least partially.

17: The torque transfer device of claim 16, wherein:
the actuating element includes a first ring section and a second ring section;
the two ring sections are positioned in a plane perpendicular to the axis of rotation;
the first ring section is offset axially relative to the second ring section; and,
the first ramp section is positioned between the first ring section and the second ring section in the circumferential direction.

18: The torque transfer device of claim 17, wherein:
the control disk includes a first control disk section and a second control disk section;
the two control disk sections are positioned in a plane perpendicular to the axis of rotation;
the first control disk section is offset axially relative to the second control disk section; and,
the control disk is positioned in relation to the actuating element in such a way that before the predefined value of the torque is exceeded the first control disk section bears against the first ring section and the second ring section bears against the second control disk section.

19: The torque transfer device of claim 17, wherein the first ramp section and/or the second ramp section is positioned obliquely at an acute angle relative to the first and/or second ring section and/or to the first and/or second control disk section, the angle preferably being 5° to 30°, in particular 10° to 20°.

20: The torque transfer device of claim 18, wherein the first ramp section and/or the second ramp section is positioned obliquely at an acute angle relative to the first and/or second ring section and/or to the first and/or second control disk section, the angle preferably being 5° to 30°, in particular 10° to 20°.

21: The torque transfer device of claim 14, wherein the control disk has, on a side facing toward the pendulum mass, a first friction surface and in that the pendulum mass has, on the side facing toward the control disk, a second friction surface, the two friction surfaces being designed to brace an oscillating torque of the pendulum mass relative to the spring damper when there is frictional contact.

22: The torque transfer device of claim 14, wherein there is a spring element positioned between the control disk and the pendulum flange, the spring element being designed to provide a separation force to space the pendulum mass apart axially from the control disk.

23: The torque transfer device of claim 22, wherein the spring element is designed as a diaphragm spring.

24: The torque transfer device of claim 14, wherein:
the control disk has a first control disk zone, a second control disk zone and a third control disk zone;
the control disk zones are connected to each other;
the first control disk zone is positioned parallel to the axis of rotation;
the second control disk zone is positioned in a plane running perpendicular to the axis of rotation;
the third control disk zone is located radially outside bordering on the second control disk zone;
the third control disk zone is positioned in a plane perpendicular to the axis of rotation and offset axially from the second control disk zone; and,
the third control disk zone is positioned axially between the second control disk zone and the pendulum mass.
